(19) United States
(12) Patent Application Publication
(10) Pub. No.: US 2010/0248202 A1
(43) Pub. Date: Sep. 30, 2010

(54) Multi-component learning kit

(76) Inventors: Walter Bennett Thompson, Piney Flats, TN (US); Beverly JeanneFranklin-Thompson, Piney Flats, TN (US); Betsy Buchanan Austin, Telford, TN (US); Dale Lee Atkinson, Johnson City, TN (US)

Correspondence Address: Mark L. Davis, 633 Harmony Road, Jonesborough, TN, 37659, US

(21) Appl. No.: 12/798,045

(22) Filed: Mar. 29, 2010

Related U.S. Application Data
(60) Provisional application No. 61/211,372, filed on Mar. 30, 2009.

(51) Int. Cl. G09B 23/00; G09B 7/00

(52) U.S. Cl. 434/276; 434/362

(57) ABSTRACT

A learning kit having a literary component that includes at least one story, wherein the story has described therein a problem; an experimental component wherein the problem posed in the story is quantitatively and/or qualitatively analyzed using experimental hardware and procedures provided in the kit; and a means for verifying successful completion of the experiments wherein successful completion of the experiments is required in order to progress the story. In one embodiment, the means for verifying successful completion of the experiments is a written letter or document that that is opened after the experiments are completed to verify the results. The letter or other printed document includes printed matter to progress the story. In another embodiment the means for verifying successful completion of the experiments is digitally recorded media recorded on digital media such as a compact disk, DVD or a remotely accessible computer. Also disclosed is a method for improving an individual's educational knowledge base in at least one science-based subject matter wherein the individual utilizes the above kit.

### CROSS REFERENCE TO RELATED APPLICATIONS

This application is the non-provisional filing, and claims benefit thereto, of the earlier filed provisional application having U.S. Ser. No. 61/211,372 filed Mar. 30, 2009 the entire disclosure of which is incorporated herein by reference.

### FIELD OF THE INVENTION

The present invention is directed to a multi-component educational kit. More particularly, the present invention is directed to a multi-component educational kit having a literary component, a hands-on experimental component, and a verifying component for verifying, correcting or redirecting user experimentation and analytical reasoning.

### BACKGROUND OF THE INVENTION

The field of Applied Sciences, (such a physics, mathematics, chemistry, and biology) requires the student to grasp and understand a variety of fundamental skills in order to postulate, analyze and deduce solutions to related problems. Historical classroom teaching has emphasized imparting information to the student via lectures, textbooks and solving problems, but have left learning primarily to the student to grasp and practice the rule or theorem in solving a problem. This process tends to be disjointed and inefficient.

The teaching of problem solving is inadequately handled in the typical course of instruction. Generally, science and engineering textbooks do not show problem solving as the truly messy task that it is. Computers have provided opportunities for signification advances in the educational process. Computers have been increasingly used in teaching, both in classroom instruction and for remote access to instructors, discussion groups, and in providing solutions to problem solving technique. Much educational software is based on a teacher or tutor model in which the system guides the user in specific areas with predefined objectives and information to be learned.

Various education kits have been proposed to help students improve their educational knowledge base. These devices are generally limited in subject matter scope and do not provide the student a means to learn how to approach and solve real world problems while furthering the student's understanding of the subject.

For example, British patent GB 1 233 329 entitled “Educational Device For Teaching Density” discloses a kit specific to the concept of density and more specifically, toward the relative weight of solids. The kit is targeted to preschool aged children who most likely are unable to read. The kit accomplishes its objective by using a double pan balance and comparing weights of the same size solid objects to see which block of solid material is heavier. The kit is designed to be self correcting through the use of color coding. If the color code on the bottom of the block matches the code in the corresponding recess that it has been placed in, the answer is correct. If there is not a match, then the experiment must be repeated. This invention does not utilize a plurality of experiments, as the comparative weighing of the objects is essentially a single experiment. Additionally, an incorrect answer to the experiment does not lead to a wrong solution to a potential real world problem; it just means the order of the blocks needs to be changed. Finally, there is no literary component as a venue for presenting and solving a problem, and the self correction mechanism is of questionable use in that the experimental process can be circumvented simply by looking at the bottom of the objects and matching them with the appropriate recess.

U.S. Pat. No. 4,470,821 entitled “Language Teaching Kit” discloses a kit for teaching grammatical aspects of language. The kit comprises a plurality of question cards, each containing a different sentence of a predetermined number of words and a plurality of answer cards, each containing a sentence corresponding to that on one of the question cards. The user forms sentences based on the question card and is scored according to how closely the sentence meets the requirements of the question card. While each question card could be considered an “experiment”, there is no overall conclusion to be drawn from correctly completing a plurality of experiments. Furthermore, an incorrect answer to the “experiment” does not lead to a wrong solution to a potential real world problem. Finally, there is no self correction mechanism.

U.S. Pat. No. 5,067,902 entitled “Multifunctional Block And Kit For Science Instruction” discloses a kit for science instruction that utilizes a multifunctional support block, activity cards containing directions for setting up and conducting experiments, and accessory items for conducting the experiments. This kit is designed to be self-directing and promote planning and problem solving through the use of the activity cards. The kit allows the student to work without constant teacher supervision thus leaving the student to his or her own devices to find answers to the questions on the activity cards. While this kit provides the user the opportunity to conduct a plurality of experiments, there is no literary component as a venue for presenting and solving a problem and no overall conclusion to be drawn from correctly completing a plurality of experiments. Furthermore, an incorrect answer to any one of the experiments does not lead to a wrong solution to a potential real world problem.

U.S. Pat. No. 5,813,865 entitled “Methods And Apparatus For Teaching Science And Engineering” discloses an interactive multimedia computer system which is used to simulate the performance of scientific experiments on the computer screen. This apparatus is designed to provide an environment for conducting a plurality of experiments that demonstrate scientific theory in a virtual setting as opposed to a real physical laboratory setting. Experimental outcomes are based on parameters selected by the user. The user is provided feedback on the outcome of the experiment and must correct errors before being allowed to move forward in the program. The user is also quizzed on subject matter retention. This quiz is a review of knowledge gained and does not require the user to reach a conclusion or solution to a real world situation. Furthermore, an incorrect answer to any one of the experiments does not lead to a wrong solution, as is possible in a potential real world problem. Finally, there is no literary component as a venue for presenting and solving a problem.

U.S. Pat. No. 6,261,103 entitled “System For Analyzing and/or Effecting Experimental Data From A Remote Location” discloses an interactive computer system for teaching laboratory based sciences. The system includes a data acquisition module, internet based coursework database, and internet based interactive software tools. The system is designed to provide the user course content and allow the user to remotely interface with a laboratory to conduct experiments and retrieve data from those experiments. This system serves as a remote classroom and does not require the user to reach a conclusion or solution to a real world situation. Furthermore, an incorrect answer to any one of the experiments does not lead to a wrong solution to a potential real world problem. Finally, there is no literary component as a venue for presenting and solving a problem.

U.S. Pat. No. 6,529,705 entitled “Computerized Scientific Method Educational System For Collecting And Analyzing Data From Prerecoreded Experiments” discloses a system that combines the use of interne based coursework with pre-recorded laboratory based experiments. Users select and view the experiments, collecting and analyzing experimental data. The system is designed to automatically provide instructional feedback based on the experimental data captured. While this apparatus focuses on providing a plurality of experiments and corrective feedback on experimental results, it does not require the user to reach a conclusion or solution to a real world situation. Furthermore, an incorrect answer to any one of the experiments does not lead to a wrong solution to a potential real world problem. Finally, there is no literary component for presenting and solving a problem.

U.S. patent publication number 2007/0172798 entitled “Learning Kits And Method For Tutoring And Teaching Learners” discloses a kit useful for learning development in students who may be functioning below their academic peers. The kits include a story, instructional sheet, and activities directed to build reading comprehension, vocabulary, language skills, science, history, and the like. The kits are designed to be self contained with activities in a game format. The activities are purposely selected to accompany the context of the story, but are not integrated as a part of the story line. This kit is designed for use by a tutor and is not self directed. Additionally, the activities are in a game format, not an experimental format and are not designed to be integral to the story, allowing the story or the activities to be completed independent of each other. These kits promote learning of basic educational principles, but do not provide the user the opportunity to apply the knowledge to problem solving.

WO 94/25785 entitled “Modular Laboratory Equipment And Coupling System” discloses a personal miniaturized labware test kit for performing a plurality of chemical tests and procedures. The kit includes devices or tools for experimentation along with instructions for use. However, this kit does not utilize a literary segment, such as a story, that requires the reader's intervention through application of concepts learned to progress the story.

WO 2006/108194 entitled “Educational Jigsaw Puzzle” discloses a kit comprised of a board and pieces that, when located correctly on the board, spell out scientific principles, theorems, formulas, equations, laws, and other relationships, functions and information. The target area and outcome of this invention is for students to evidence a skill of playfully mastering to memory a law/theorem/rule/formula. It is not designed to teach or improve skills in the scientific method or analytical reasoning.

Accordingly, there is still a need for an educational kit that involves the user with hands-on experience, is challenging and provides the student a means to learn how to approach and solve real world problems while furthering the student's understanding of the subject matter and substantially without adult intervention.

### SUMMARY OF THE INVENTION

Briefly, the present invention is a multi-component learning kit having a) a literary component comprising at least one story having described therein a problem to be solved; b) an experimental component wherein the problem is quantitatively and/or qualitatively analyzed using experimental hardware, reagents and procedures provided in the kit; and c) a verifying component comprising a means for verifying successful completion of the experiments to progress the story. In one embodiment, the means for verifying successful completion of the experiments is a written means which may accompany the kit or be provided to the user by a separate letter. In another embodiment, the means for verifying successful completion of the experiments is a digital means, which may be included in the kit, such as a CD or DVD, or provided by a remote access computer internet interface. The digital means facilitates self-verifying, correcting and/or redirecting user experimentation and analytical reasoning by use of a computer, PDA or other stationary and/or hand-held digital device. However, regardless of the means selected, uniquely, successful completion of the experiments is required in order to sensibly progress the story.

It is an object of the present invention to provide a learning kit that fosters sound analytical technique with minimum adult assistance or intervention in the learning process. This can best be accomplished by providing the student with educational materials which do the instruction. Such educational material can be designed to enable the student to work at their own pace and can provide differing levels of progressively greater intellectual challenge to the student.

It is another object of the present invention to provide a learning kit that provides a means for self-correcting analytical technique and deductive reasoning so that the student or user is able to determine for himself or herself whether s/he has properly carried out the experiment and correctly derived the answer to the problem. This eliminates or reduces the need for adult assistance or intervention in the learning process.

Another object of the present invention is to provide a learning kit that fosters scientific experimentation practice, technique and accuracy geared to the user's level of understanding without oversimplification.

Another object of the present invention is to provide a learning kit that provides a combination of literary and experimental procedures that fosters a clear and simple relationship between the problem, observations, operational steps, scientific concept and analytical reasoning.

Another object of the present invention is to provide a learning kit that provides experiments tied to a story that requires successful completion of the experiments in order to progress the story.

### BRIEF DESCRIPTION OF THE DRAWINGS

FIG. 1 is an illustration of a kit 10 in accordance with the present invention. The kit depicts a booklet or folder 20 and literary components 22 and 24 contained in the booklet or folder. Further depicted are kit hardware 25, such as test tubes, measuring dropper, magnet, sample vials and magnifying device.

FIG. 2 is a block diagram of a remote access computer interne interface useful in self-verifying, correcting or redirecting user experimentation and analytical reasoning.

### DETAILED DESCRIPTION OF THE INVENTION

The present invention is directed to a multi-component learning kit. The term “kit”, “kits” and “learning kit” are used interchangeably herein. The learning kit provided herein comprises a collection of literary stories, instructions, tools and supplies useful for the user or student to perform qualitative and/or quantitative experimentation and analysis with minimum adult assistance or intervention in the learning process.

The educational kit is adapted to build a user's understanding and application of the principles of basic science, analytical reasoning, and reading comprehension. The user is required to read and understand the story and conduct the experiments to complete the story. A novel feature of the present invention is to employ experiments that are self-contained, designed to integrate with the story line to insure concepts are correctly learned and properly applied by the user, and require successful experimental completion in order to complete the story. Although the user or student may have certain observations or acquire data associated with the experimental analysis component of the kit, such observations or data may be incomplete or inaccurate due to errors in technique, or contamination of evidence. Thus, uniquely, the present kit reinforces the importance of correct technique to obtain unquestionable results.

In accordance with the present invention, the kit includes: a literary component comprising at least one story having a problem described therein; an experimental component wherein the problem is quantitatively and/or qualitatively analyzed using experimental hardware and procedures provided in the kit; and a verifying component comprising a means for verifying successful completion of the experiments to progress the story. Uniquely, successful completion of the experiments is required in order to progress the story.

The literary component of the present invention comprises a book, story, or compendium of short stories which may be bound or loosely associated in a folder wherein the user is a participant in solving one or more problems described in the story. The kit includes instructions to the user with appropriate written procedures for performing experimental analysis safely. The literary portion of the kit is largely self-contained and may include work sheets, graph paper, charts, maps, and the like to record the observations and user's progress during the course of the activity. The kit may further contain supplemental materials or additional activities that are designed to support or strengthen the desired skills performed in conjunction with the story.

In another embodiment, the kit includes a second book, story, or compendium of short stories for a tutor or supervising person wherein the tutor is provided with all the necessary instructions for assisting the user or student and engaging the entire kit, including the experimental component and optionally, the verifying component of the kit.

The literary and experimental components of the kit can be contained in a bag or other type of container that allows the user to transport and store the kit in a convenient manner. Kits may be designed to cover skills of any desired subject matter and further any level of ability within the subject area. Although a single kit may be utilized in a particular subject matter, it is within the scope of the present invention for multiple kits to be employed wherein stories and/or experimental components for each kit may cumulatively progresses or build sequentially on each other.

In another embodiment, the literary component of multiple kits may be utilized to cumulatively progresses so that the use of multiple kits is focused on advancing at least one literary skill such as: reading comprehension; language development; vocabulary enhancement; phonics; cultural literacy; or any combinations thereof.

In accordance with the present invention the kit includes an experimental component wherein the aforementioned problem is quantitatively and/or qualitatively analyzed using experimental hardware and procedures provided in the kit. Although the kit is designed to be self-contained, in that the student or user will not need to provide experimental hardware for performing the analytical procedures, an activity that requires generally accessible items, such as water, vinegar, pens, crayons, paper, or scissors should not be considered to render an experiment not self-containing, since such items are likely to be readily available in a typical household setting.

In the course of the experimental analysis, the user performs experiments, records observations and acquires data that enhances the users understanding of the concepts being tested, and corrects misunderstandings through the requisite problem solving. For example, the user may make observations and obtain data related to the physical characteristics of the clue or piece of evidence, such as the object's shape, size, color, smell, whether the object is a solid or liquid, is the object slick or rough. The kit may include litmus paper to determine pH, whether the clue is soluble in water, or in a mildly acidic solution (such as vinegar), is the object magnetic, and the like.

With respect to chemical analysis, the kit may include various reagents, glassware, compounds, and procedures for preparing solutions of a known concentration. Such procedures are well known in the chemistry art and are disclosed, for example, in reference materials such as Chemical Principles, W. L. Masterton and E. J. Slowinski, 3^{rd} ed. W.B. Saunder Co., (1973), the disclosure of which is incorporated herein by reference.

In accordance with the present invention, the kit includes a means for verifying successful completion of the experiments in order to progress the story. In one embodiment, the means for verifying successful completion of the experiments is a letter or other printed document contained in the kit that is opened, accessed or revealed after the experiments are completed to verify the results. In another embodiment, the letter or printed document may be mailed, faxed, electronically forwarded or otherwise sent or revealed to the user after notice that the experiments are completed and results are verified. In either embodiment, successful completion of the experiments is required in order to sensibly progress the story

In another embodiment of the invention, the means for verifying successful completion of the experiments is by a digital verifying means comprising digital media. Non-limiting examples of such digital media include compact disks (CDs), DVD recordings, flash drives, and a remotely accessible computer. The digital media has recorded thereon digital information, i.e., digitally recorded media, programs, applications, data, video, procedures, and the like that facilitates the access of experimental results, procedures or other evaluative information, programs, applications and the like. One skilled in the art of sound recording, taking digital images, or recording digital movies on a standard desktop computer is adept to making such digitally recorded media. Programs commercially available for either a Macintosh and/or PC for this purpose are well known, with new and more advanced programs appearing on the market every year.

For purposes of clarity, the term “digital media” as used herein will mean the physical media (i.e., CD, DVD, etc.), and the term “digitally recorded media” refers to the digital content recorded onto the digital media. Non-limiting examples of such digitally recorded media includes information, analytical and dialogue programs and/or applications, data, videos, procedures, and the like. It is also within the scope of the present invention wherein the digital recorded media may further facilitate the access of experimental results, procedures or other evaluative information recorded on the digital media. The digital verifying means facilitates self-verifying, correcting and/or redirecting user experimentation and analytical reasoning by use of a phone, computer, PDA or other stationary and/or hand-held digital device that provides a means for communicating or conveying information between the user and the digital media. However, regardless of the means selected, successful completion of the experiments is required in order to sensibly progress the story.

In one embodiment wherein digitally recorded media is used, the digitally recorded media can include a constructive-dialogic means for verifying, correcting and/or redirecting user experimentation and analytical reasoning. Utilizing the digital verifying means the user or student can verify data and observations, and optionally, seek intervention or redirection if the results are outside of a predetermined range or deviation. Such intervention tools may include, without limitation, audible beeps, dings or whistles if the data is incorrect; audible or written suggested corrections to experimental analysis, calibration of tools, such as thermometers, pH meters and the like, or even a video of one or more kit experimental procedures and may further include analytical results of such experimental procedures for the user or student to assess errors in his/her experimental technique.

It is also contemplated in another embodiment that such constructive-dialogic means includes an interactive means for prompting the user to repeat one or more of the quantitatively and/or qualitatively experimental procedures provided in the kit if the results are wrong or outside of an acceptable deviation.

In another embodiment, the interface to access a remote computer includes a means for a local computer or other communicative device to link real time communication between the user and an off-site computer. Non-limiting examples of such computer links include wired, such as a telephone modem, ethernet network, and the like, and wireless communication interfaces, such as WIFI, satellite, cell phone and the like. Interactive modifiable programs for internet type access to a remote computer are well known to those skilled in the art of internet web site creation. Such internet interface modifiable programs are available from numerous commercial entities, such as MICROSOFT® CORPORATION or ADOBE® (such as ADOBE® DREAMWEAVER®) to name a few. Typically, these computer interface modifiable programs permit the web creator, i.e., typically known as the web master, to create a portal or site on the remote access computer for the user to verify, in real time, data and observations developed in a particular experiment utilizing a laboratory setting that is remotely located relative to the server.

In any of the aforementioned digital means for verifying the experiments, it is desirable for the digital media to include an electronically addressable storage means having stored information related to a particular topic and a means for selecting said electronically addressable stored information. Such electronically addressable storage means and means for selecting the electronically addressable stored information are well known to a web site creator for the computer or digital storage media art for CDs or DVDs.

In practice, real experiments performed by the user or student generally have a predefined range of humanly perceptible experimental parameters and results. A range of results are stored on the electronically addressable storage means. Using interactive software tools, a kit developer can design a subject matter or course study by selecting materials and related laboratory experiments. In the case were an internet connection is desired, the kit developer creates an Internet web page, which provides students with an interactive, computer-based visual interface with analysis tools. Typically, the user's interface includes both input and output devices such as visual displays, mouse, keyboard, and speakers.

In another embodiment, similar to those that may be provided on a CD or DVD provided in the kit, the constructive-dialogic tools of the remote access computer can include an interactive prompting tools for questioning the user in real time regarding various features of the experimental data. Again, such programming tools are typically available in the internet interface modifiable programs used in creating the web site for addressing the remote access computer.

The remote access computer includes an electronically addressable storage means or device having stored information related to a particular topic and a means for selecting the electronically addressable stored information. This way, a user or student is analyzing the data in real-time with respect to an in-progress experiment. In the event the interactive analysis tool determines that the data or observations may be questionable or outside of an acceptable deviation, the prompting tool can alert the user or student to potential errors in the experiment or analytical procedures. The prompting tool may also be adapted to signal the user to perform various measurements with respect to the experimental data, such as recording temperature, or whether the sample/test tube feels hot or cold indicating whether the reaction is exothermic or endothermic.

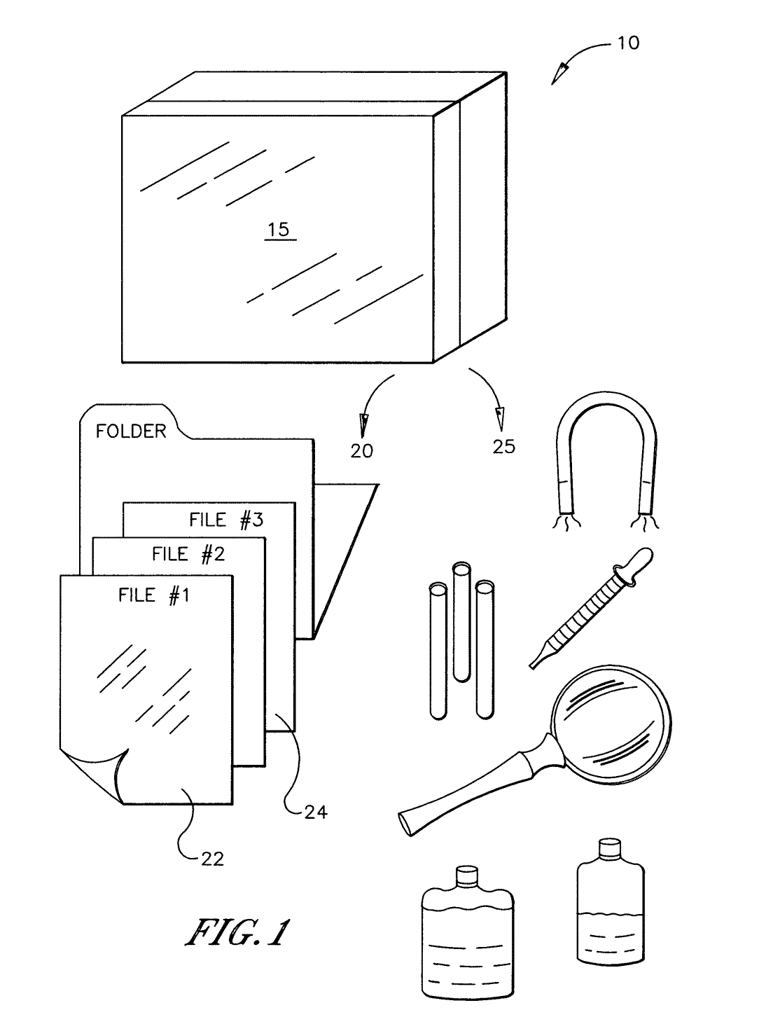

Referring to FIG. 1, the kit 10 is housed within a suitable storage container such as box 15 designed to hold the contents of the kit 10. Within box 15 is a booklet, envelope, or folder 20 containing a short story 22, experiment instructions 24, and other paper based components pertinent to the story and execution of the experiments. The kit 10 also contains the experiment materials 25 required to conduct the experiment. The kit 10 is designed to provide self-directed learning and preferably does not require the participation of a teacher or tutor. Upon receipt of the kit 10, the user opens the container 15 and removes the story 22 from the folder 20. The story 22 is read by the user, who then follows the instructions utilizing materials 25 contained within the kit 10 to conduct the experiments. After conducting the set of experiments, the user must solve a problem created as a part of the story using the knowledge gained from the previously conducted experiments. The correct conclusion to the problem and resolution of the story is attained through the successful completion of the experiments.

In order to provide self-directed learning, feedback is provided by using a means for verifying successful completion of the experiments. Successful completion of the experiments is required in order to sensibly progress the story. As discussed above, the means for verifying successful completion of the experiments can be is a letter or other printed document contained in the kit that is opened after the experiments are completed; a letter or printed document separate from the kit; or a digital means that utilizes digitally recorded media selected from a compact disk, DVD, a remote access computer internet interface, or other stationary and/or hand-held digital device.

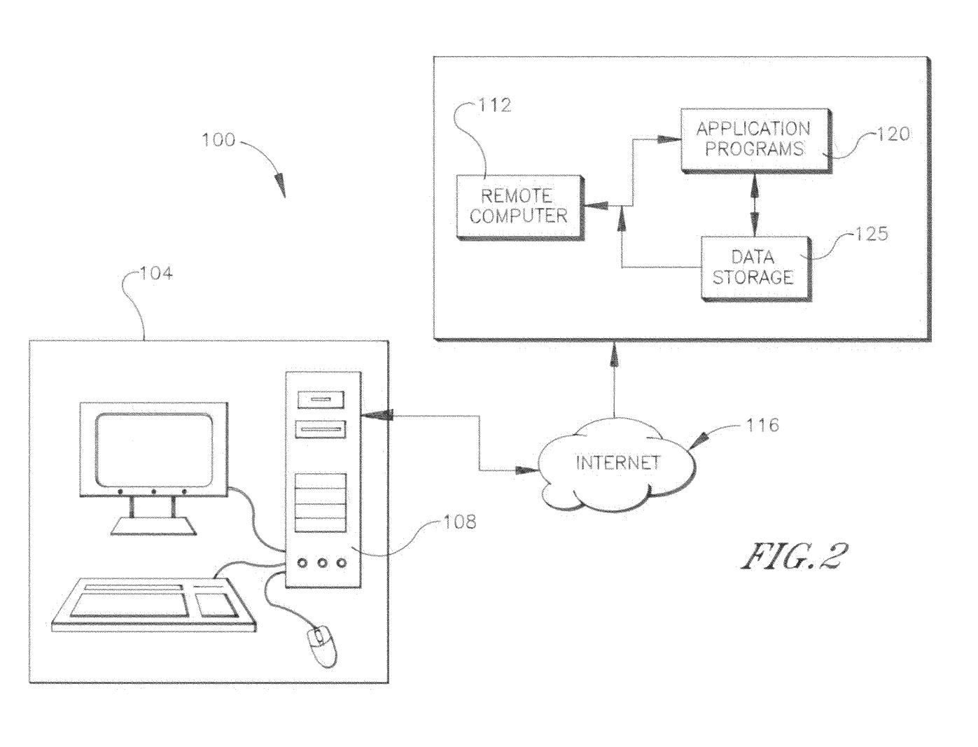

Referring to FIG. 2, a schematic block diagram of a remote access computer internet interface system 100 for analyzing user experimentation and analytical reasoning is illustrated. As shown in the illustrated embodiment, a local workstation 104 can include a personal computer 108 (but may be a personal digital assistant (PDA), phone or other hand-held or stationary device) which includes a means for data input such as keyboard and/or a pointing device, such as a mouse or track ball, a screen, and the like for human communication interface by way of internet-based communication signals 116 to the remote access computer 112. The remote access computer 112 includes application programs 120 and data storage space 125. Optionally, resident on the remote access computer 112 are one or more constructive-dialogic programs for verifying, correcting and/or redirecting user experimentation and analytical reasoning. The constructive-dialogic programs include or have access to an electronically addressable storage device, such as a hard drive, flash drive or other accessible memory module or device having stored information related to a particular topic. Desirably, the electronically addressable storage device and data storage space 125 are resident on the remote access computer 112 and may be part of a larger storage drive that may be further partitioned for specific application uses and/or data storage. Such storage devices and means for partitioning such devices are well known to those skilled in the computer arts. To access the information, the constructive-dialogic programs include a means for selecting the electronically addressable stored information. Such selecting means can be in the form of hyperlinks, GUI interface, radio buttons or accessible subroutines known to those skilled in the computer art. Accordingly, the user, via the local workstation 104, addresses the remote access computer 112 by way of internet-based communication signals 116. The user then accesses the stored information on the remote access computer 112 relative to the subject matter or kit being used. Based on the conclusion given for the problem, the user will know if the problem has been successfully solved. In the event of an incorrect conclusion, the feedback provides helpful hints or tips that allow the user to re-execute the experiments and come to the proper conclusion before a remaining or continuing portion of the story is revealed.

Another aspect of the present invention is a method for improving an individual's educational knowledge base in at least one science-based subject matter. The method includes the steps of providing at least one multi-component learning kit as described above; reading the literary story therein wherein the story has at least one problem requiring analytical experimentation; performing analytical experimentation and collecting data; verifying successful completion of the experiments from the collected data; and sensibly progressing the story after successfully completing the experiments. Optionally, the method further includes providing constructive-dialogic intervention tools in a digital recorded media for verifying, correcting and/or redirecting user experimentation and analytical reasoning. In another embodiment, the method may further optionally include prompting the individual to repeat one or more of the quantitatively and/or qualitatively experimental procedures provided in the kit when the dialogic tools for verifying, correcting and/or redirecting user experimentation and analytical reasoning identifies parameters outside of an acceptable deviation. With respect to an in-progress experiment, the prompting tool can alert the individual to potential errors in the experiment or analytical procedures.

The present invention is illustrated in greater detail by the specific examples presented below. It is to be understood that these examples are illustrative embodiments and are not intended to be limiting of the invention, but rather are to be construed broadly within the scope and content of the appended claims.

### Example 1

In this example, the focus is on the principles of evaluating the chemical and physical properties of powders and crystals. One story for the kit is titled “The Nefarious Bakery”. The story line is centered around a police detective investigating a baker for smuggling pirated video game software. The bakery uses a proprietary “secret ingredient” in the cakes. The detective knows it is a white powder from a discussion with one of the employees. One day the detective finds a copy of a suspect video game lying on the side of the road with traces of a white powder and cake icing on it. The detective thinks he may have the break his case needs. The detective needs to have the powder identified and sends it off to a lab for testing. In the story line, the kit user joins a select group of scientists that help solve science based problems. In the story, the detective has sent the powder to this group for testing. The kit user becomes the scientist charged with the task of identifying the powder and thus is integral to the story and its outcome. In addition to the story, the kit contains the following items:

1. A predetermined number of individual bags of “known” white powders, such as sugar, salt, flour, baking soda, and citric acid.

2. One bag of the “unknown” powder collected from the disc.

3. A magnifying device, such as a magnifying glass, jeweler's loupe or hand held microscope.

4. A number of test tubes with stoppers.

5. A cardboard insert for the box with a built in test tube rack.

6. A number of examination papers for observing the powders.

7. A plastic sampling spoon.

8. A number of pieces of neutral litmus paper.

9. Safety goggles and plastic gloves or other safety equipment.

10. A “Case File” with educational information and instructions sheet that discusses safety, the concepts of the experiments to be performed, and how to perform them.

11. A data sheet for recording observations.

12. An appropriately sized plastic dropper.

13. A number of sheets of laboratory wiping tissues

Relevant information from the case file is presented below:

Lab Case File No.: 1001

Agent: Maxwell Sweetfeet, Sterling Police Dept., 101 Jailbird Rd, Anywhere U.S.A.

Case History:

The lab was contacted by Agent Maxwell Sweetfeet of the Sterling Police Department concerning a computer disk covered in an unknown white powder. Agent Sterling was advised to carefully bag the disk to prevent powder loss and immediately forward it to the Science Team for analysis. The sample was received and this Case File was initiated. The sample arrived in a plain brown envelope. Inside the envelope was a clear plastic bag containing a round CD type computer disc covered in a white powder. The powder on the disc was scraped into a small bag for testing.

Analysis Request:

Determine the identity of the white powder from the disc. Determine if it matches the secret ingredient in the Nefarious Bakery Icing.

Experiment #1-Physical Characterization

Everything in the universe that has mass and takes up space is called matter. All matter is made up of smaller pieces called particles. A solid is matter that has a definite shape. To make this shape the particles are held close together and move very little. These particles can be broken into smaller pieces and will eventually form a powder or a crystal. A powder is a substance composed of finely ground or pulverized loose solid particles. A crystal is a transparent solid that has a repeating arrangement of atoms or ions. This gives the particles structure and shape. Examples of crystals and powders are depicted on the Reference sheet in the kit. Examine each with your magnifier.

In this experiment, you will examine the structure of particles and classify or place them in groups based on physical appearance or how they look. The particles you will examine are either a powder or crystal. This experiment requires the following materials: a)-plastic bags of flour, salt, baking soda, citric acid (known samples); b)-plastic bag with an unknown sample; c)-sample observation sheet; d)-sampling spoon; e)-lab tissues; f)-magnifier; and g)-Lab Data Sheet. Record your observations on the “Lab Data Sheet”.

Step 1:

Select a known sample and the sample observation sheet for that sample. Place a spoonful of the sample on the sheet and gently spread it out. Clean the spatula with a tissue to avoid contaminating the other samples.

Step 2:

Using the magnifying device, examine each sample. Compare what you see to the pictures contained on the Reference sheet provided in the kit and determine if the sample is a powder or a crystal. If the sample looks like one of the pictures, it is a crystal. If it does not look like one of the pictures, it is a powder. Find the column labeled “Crystal or Powder” on the Lab Data Sheet and make a check mark in the powder column if the sample is a powder or in the crystal column if the sample is a crystal. Repeat steps 1 and 2 for the known samples first, then the unknown sample.

Experiment #2-Solubility

Particles (also known as the “solute”) like those examined in experiment 1 will sometimes dissolve in a liquid (also known as the “solvent”). That is, they seem to disappear when mixed with a solvent. They do not really disappear. The solvent pulls apart the solid particles until they are too small to be seen. Particles that do not dissolve cannot be pulled apart by the liquid. Solubility is a measure of the amount of material that will dissolve in another material. In this experiment, you will use water to try and dissolve the samples, and classify the samples based on their solubility. When a solid dissolves in a liquid, it makes a solution and the particles can no longer be seen.

This experiment requires the following materials. Record your observations on the “Lab Data Sheet”. This experiment requires the following materials: a)-bags of flour, salt, baking soda, citric acid, and unknown sample; b)-sampling spoon; c)-lab tissues; d)-test tubes, stoppers, and test tube holder; e)-dropper; f)-small cup of water*; and g)-marker*.

*Items (f) and (g) are not provided in the kit.

Step 1:

Label one test tube with the letter F for flour. Using your sampling spoon, place a spoonful of flour in the test tube. Clean the spatula with a tissue to avoid contaminating the other samples. Label a second test tube with the letter S for salt. Using your sampling spoon, place a spoonful of salt in the test tube. Clean the spatula with a tissue to avoid contaminating the other samples. Label a third test tube with the letter B for baking soda. Using your sampling spoon, place a spoonful of baking soda in the test tube. Clean the spatula with a tissue to avoid contaminating the other samples. Label a fourth test tube with the letter C for citric acid. Using your sampling spoon, place a spoonful of citric acid in the test tube. Clean the spatula with a tissue to avoid contaminating the other samples. Label the last test tube with the letter U for unknown. Using your sampling spoon, place a spoonful of the unknown sample in the test tube. Clean the spatula with a tissue to avoid contaminating the other samples.

Step 2:

Add 1 dropper full of water to one of the test tubes. Place a stopper in the test tube and shake it while counting to 20. Is the resulting mixture cloudy or clear? Let the mixture sit for 30 seconds. Can you still see the sample in the bottom of the test tube? This is undissolved material. If there is undissolved material, shake the test tube again while counting to 20. Is the resulting mixture cloudy or clear? Make a check mark on the Lab Data Sheet in the “Undissolved” column beside each sample that remained cloudy. Make a check mark on the Lab Data Sheet in the “Dissolved” column beside each sample that forms a clear solution.

Repeat step 2 for the remainder of the test tubes. Keep the test tubes and mixtures for the next experiment.

Experiment #3-Is it an Acid?

An acid is a substance that reacts with a base to form a salt. This reaction can be seen when blue litmus paper changes colors when it comes in contact with an acid. The paper contains a base that will react with the acid to form a red color. In this experiment, you will use the solutions made in experiment 2 and blue litmus paper to determine if any of the samples are an acid.

This experiment requires the following materials: a)-Solutions from Experiment 2; and b)-blue litmus paper. Record your observations on the “Lab Data Sheet”.

Step 1

Remove the stoppers from each test tube. Remove 5 strips of blue litmus paper from the container.

Step 2:

Hold one of the test tubes in one hand and a slip of litmus paper in the other hand. While holding onto the litmus paper, insert the litmus paper into the test tube. Gently tilt the test tube and allow the solution to soak the bottom half of the paper. Remove the litmus paper from the test tube. Make a check mark on the Lab Data Sheet in the “Turns Red” column if the sample turns the litmus paper red. Repeat step 2 for the remaining test tubes. Keep the test tubes and mixtures for the next experiment.

Experiment #4-Reaction with Vinegar

Vinegar is an acid (acetic acid) that will react with some solutions to form a gas called carbon dioxide. When this reaction takes place, the carbon dioxide is released from the solution and bubbles form. In this experiment, you will use the solutions made in experiment 2 to see if any of the samples react with vinegar.

This experiment requires the following materials: a)-solutions from Experiment 2; b)-dropper; and c)-white vinegar*. Item (c) is not provided in the kit. Record your observations on the “Lab Data Sheet”.

Step 1

Fill the dropper with vinegar. Add a few drops of vinegar to each of the test tubes. Make a check mark on the Lab Data Sheet in the “Reacts with Vinegar” column beside each sample that reacts with vinegar.

Make a Conclusion

Based on the 4 experiments you should now be able to determine what the unknown sample is. Compare your observations for the unknown sample to each of the known samples of flour, salt, baking soda, and citric acid. See which of the known samples matches the unknown sample. The materials that match will be what the unknown sample is. Record the result on your Lab Data Sheet. Log onto your Science Team account and enter your findings. Properly dispose of any used materials. Clean all glassware and stow away for future use. Be sure to save the materials from your kit. You may need them for your next mission.

When the user has determined the sample identity, he/she provides the solution to a remote access computer database via the internet. The answer is checked using the database and any errors are identified. If the answer is correct, the user is notified by electronic means that the answer is correct and the remainder of the story is revealed. If the answer is incorrect, the remainder of the story is not revealed, and the user is sent back to their “lab” to repeat the analysis. The user may also be presented with a series of questions to help them figure out where they might have erred in their experimentation. Additional tips for performing the experiments may also be provided. Through this the user is taught how to approach testing an unknown substance of limited quantity, how to safely perform these types of experiments, the physical and chemical attributes of the substances tested, how to approach making and documenting observations, how to develop and use a logic table, and how to draw conclusions from a given set of data.

### Example 2

In this Example, the user focuses on the biological attributes and wildlife adaptations of bird beaks. The story centers on robberies occurring from the fifth floor of various apartment buildings around town. A flying circus having different bird species is in town and the detectives are suspecting the birds might have been trained to commit the robberies. The detectives decide to contact the scientists to see if they can determine if the birds in the circus may be connected to the robberies. The user becomes the scientist charged with analyzing the evidence to determine whether or not the birds are connected with the robberies. For conducting the experiments, the kit contains:

1. Pliers, chop sticks, tweezers, and a clothespin.

2. Food: (synthetic) worm, rice, raisins, small birdseed, and large birdseed.

3. Lab Data Sheet depicting numerous birds types and their beaks.

Relevant information from the case file is presented below:

Case File No.: 1002

Agent: Aviary Cheeks, Clearview Police Dept., Cloud, U.S.A.

Case History:

The lab was contacted by Detective Aviary Cheeks of the Clearview Police Department concerning recent robberies committed in the area. There are several common links in the robberies:

All robberies were committed on the fifth floor in multiple floor apartment buildings. There was no sign of forced entry. In all cases the windows had been left open. All apartment buildings were within sight of the main tent for the Clearview Park Magic Show & Flying Circus (A show utilizing trained birds).

Detective Cheeks is hypothesizing that the birds may have been trained to commit the crimes and would like the lab to perform a series of tests to evaluate this hypothesis.

Analysis Request:

Based on different foods eaten by birds, determine if birds would be able to pick up the stolen objects and if so, what kind of birds would most likely be able to pick up the stolen items.

Contents of Test Kit:

Instructions:

1. Place tools on one side of the desk. Think about the different types of bird beaks each tool can represent. For example, the pliers might be a short, thick beak.

2. Put the food materials in separate plates. Place these items on the other side of the desk.

3. Place one type of food in the middle of the desk and try picking up the food with each “beak”, (i.e., pliers, chop sticks, tweezers, or the clothespin). Record your observations on the “Lab Data Sheet” which “beak” works best for picking up each food.

4. Based on the observations above, would any of the “beaks” be able to pick up the stolen items:

a. Necklaces

b. Diamonds

c. Rings

d. Bracelets

e. Coins

f. Nintendo DS Games

5. Based on your observations, do you think it is possible for birds to have stolen these items?

6. If you answered Yes to question #5, on the Lab Data Sheet provided in the kit are pictures of birds. Examine their beaks and match the birds with the tools and the item each one may have stolen.

Log in to your Science Team account and enter your findings. Be sure to save all materials from this mission. You may need them for your next mission.

The user performs the experiments as directed, notes observations, and draws conclusions based on the observations. If the experiments have been performed correctly, the user should recognize the ability of certain birds to pick-up the items and be able to identify potential birds that might have committed the robberies. When the user has made these determinations, he/she verifies the results with the written documents or digital media provided in the kit. In the case where verification is provided via a remotely accessible computer, the user provides the solution to a database through the internet. The answer is checked against the database for correctness. If the answer is correct, the user is notified that the answer is correct and the remainder of the story is revealed. If the answer is incorrect, the remainder of the story is not revealed, and the user is sent back to their “lab” to repeat the analysis. The user is also presented a series of questions to help them figure out where they might have erred in their experimentation and additional tips for performing the experiments. Through this means, the user is taught how to perform simulated tests that reflect real world situations, how nature adapts to its environment, how to approach making and documenting observations, and how logically reach a conclusion by drawing inferences from observations.

Advantageously, using a digital verification means, such as an internet component, the kits can be designed to be appropriate for all levels of education and may be packaged individually, as a group, or in a subscription format. Furthermore, a method of self-directed learning has been invented whereby the user of the kit has the educational concepts reinforced and misunderstandings corrected through the combination of both science and literature.

Having described the invention in detail, those skilled in the art will appreciate that modifications may be made to the various aspects of the invention without departing from the scope and spirit of the invention disclosed and described herein. It is, therefore, not intended that the scope of the invention be limited to the specific embodiments illustrated and described but rather it is intended that the scope of the present invention be determined by the appended claims and their equivalents. Moreover, all patents, patent applications, publications, and literature references presented herein are incorporated by reference in their entirety for any disclosure pertinent to the practice of this invention.

What is claimed is:

1. A learning kit comprising:
a) a literary component comprising at least one story, said story having described therein a problem;
b) an experimental component wherein said problem is quantitatively and/or qualitatively analyzed using experimental hardware and procedures provided in said kit; and
c) a means for verifying successful completion of the experiments wherein successful completion of the experiments is required in order to progress the story.

2. The learning kit of claim 1 wherein said literary component includes at least two copies of said story, and wherein one of said copies includes all the necessary instructions for assisting the learning and engaging the experimental component of said kit.

3. The learning kit of claim 1 wherein at least one of said components cumulatively progresses through the use of multiple kits.

4. The learning kit of claim 3 wherein at least one of said components that cumulatively progresses through the use of multiple kits is said literary component.

5. The learning kit of claim 4 wherein said literary component that cumulatively progresses through the use of multiple kits is focused on at least one literary skill selected from the group consisting of: reading comprehension; language development; vocabulary enhancement; phonics; cultural literacy; and combinations thereof.

6. The learning kit of claim 1 wherein said means for verifying successful completion of the experiments is a printed document that is revealed after the experiments are completed to verify the results and wherein the printed document further includes printed matter to progress the story.

7. The learning kit of claim 1 wherein said means for verifying successful completion of the experiments is a digital verifying means.

8. The learning kit of claim 7 wherein said digital verifying means includes digital media selected from the group consisting of a compact disk, DVD and a remotely accessible computer.

9. The learning kit of claim 7 wherein said digital media includes digitally recorded media.

10. The learning kit of claim 9 wherein said digitally recorded media includes constructive-dialogic means for verifying, correcting and/or redirecting user experimentation and analytical reasoning.

11. The learning kit of claim 10 wherein said constructive-dialogic means includes an interactive means for prompting the user to repeat one or more of the quantitatively and/or qualitatively experimental procedures provided in said kit.

12. The learning kit of claim 8 wherein said digital media includes an electronically addressable storage means having stored information related to a particular topic and a means for selecting said electronically addressable stored information.

13. The learning kit of claim 1 wherein said experimental component includes materials for performing said quantitatively and/or qualitatively analysis.

14. The learning kit of claim 1 wherein at least one item for quantitatively and/or qualitatively analysis is provided by the user.

15. A learning kit comprising:
a) a literary component comprising at least one story, said story having described therein a problem;
b) an experimental component wherein said problem is quantitatively and/or qualitatively analyzed using experimental hardware and procedures provided in said kit; and
c) a written means for verifying successful completion of the experiments comprising a printed document that is opened after the experiments are completed to verify the results and wherein the printed document further includes printed matter to progress the story.

16. The learning kit of claim 15 wherein said printed document is contained in the kit.

17. The learning kit of claim 15 wherein said printed document is sent to a user after notice the experiments are completed and results are verified, wherein successful completion of the experiments is required in order to progress the story.

18. A learning kit comprising:
a) a literary component comprising at least one story, said story having described therein a problem;
b) an experimental component wherein said problem is quantitatively and/or qualitatively analyzed using experimental hardware and procedures provided in said kit; and
c) a digital verifying means for verifying successful completion of the experiments wherein successful completion of the experiments is required in order to progress the story.

19. The learning kit of claim 18 wherein said digital verifying means comprises digital media selected from the group consisting of a compact disk, DVD and a remotely accessible computer.

20. The learning kit of claim 19 wherein said digital media includes digitally recorded media having a constructive-dialogic means for verifying, correcting and/or redirecting user experimentation and analytical reasoning.

21. The learning kit of claim 19 wherein said constructive-dialogic means includes an interactive means for prompting the user to repeat one or more of the quantitatively and/or qualitatively experimental procedures provided in said kit.

22. The learning kit of claim 19 wherein said digital media includes an electronically addressable storage means having stored information related to a particular topic and a means for selecting said electronically addressable stored information.

23. The learning kit of claim 19 wherein said remotely accessible computer includes a communication interface component selected from the group consisting of a wired and wireless interface wherein said communication can link real time communications between the user and an off-site computer.

24. A method for improving an individual's educational knowledge base in at leak one science-based subject matter, said method including the steps of:
a) providing at least one multi-component learning kit wherein said kit includes: i) a literary component comprising at least one story; ii) an experimental component utilizing experimental hardware and procedures provided in said kit; and iii) a means for verifying successful completion of the experiments to facilitate self-verifying, correcting and/or redirecting user experimentation and analytical reasoning;
b) reading the literary story wherein the story has at least one problem requiring analytical experimentation;
c) performing analytical experimentation and collecting data;
d) verifying successful completion of the experiments from the collected data; and
e) progressing the story after successfully completing the experiments.

25. The method of claim 24 wherein said verifying successful completion of the experiments is a printed document that is revealed after the experiments are completed.

26. The method of claim 24 wherein said verifying successful completion of the experiments is a digital verifying means comprising digital media selected from the group consisting of a compact disk, DVD and a remotely accessible computer.

27. The method of claim 26 wherein said digital media includes digitally recorded media, said digitally recorded media having a constructive-dialogic means for verifying, correcting and/or redirecting user experimentation and analytical reasoning.

28. The method of claim 27 wherein said digital media includes an electronically addressable storage means having stored information related to a particular topic and a means for selecting said electronically addressable stored information.

29. The method of claim 27 further comprising prompting the user to repeat one or more of the quantitatively and/or qualitatively experimental procedures provided in said kit when said dialogic means for verifying, correcting and/or redirecting user experimentation and analytical reasoning identifies parameters outside of an acceptable deviation.
